(19) United States
(12) Patent Application Publication
(10) Pub. No.: US 2020/0151220 A1
(43) Pub. Date: May 14, 2020

(54) INTERACTIVE REPRESENTATION OF CONTENT FOR RELEVANCE DETECTION AND REVIEW

(71) Applicant: Cogi, Inc., Santa Barbara, CA (US)

(72) Inventors: Mark Robert Cromack, Santa Ynez, CA (US); Andrew Mark Jacobson, Glen Ullin, ND (US)

(21) Appl. No.: 16/706,705

(22) Filed: Dec. 7, 2019

Related U.S. Application Data
(63) Continuation-in-part of application No. 16/191,151, filed on Nov. 14, 2018.

(51) Int. Cl. G06F 16/903; G06F 16/955; G06F 16/957; G06F 40/30; G06F 16/9038

(52) U.S. Cl. CPC G06F 16/90348; G06F 16/9566; G06F 16/9038; G06F 40/30; G06F 16/9577

(57) ABSTRACT

A content extraction and display process which process may include various functionality for segmenting content into analyzable portions, ranking relevance of content within such segments, and displaying highly ranked extractions in graphical cloud form. The graphical cloud in some embodiments will dynamically and synchronously update as the content is played back or acquired. Extracted elements maybe in the form of words, phrases, audio sequences, non-verbal visual segments or icons as well as a host of other information communicating data objects expressible by graphical display. In some cases, elements of the graphical cloud may include links to external resources such as websites or other resources.

### RELATED APPLICATIONS

This application is a Continuation-in-Part of U.S. application Ser. No. 16/191,151, filed Nov. 14, 2018 which in turn claims priority to U.S. Provisional Application Ser. No. 62/588,336, filed Nov. 18, 2017, both of which are incorporated by reference in their entirety.

### BACKGROUND

The specification relates to extracting important information from audio, visual, and text-based content, and in particular displaying extracted information in a manner that supports quick and efficient content review.

Audio, video and/or text-based content has become increasingly easy to produce and deliver. In many business, entertainment and personal use scenarios more content than can be easily absorbed and processed is presented to users, but in many cases only portions of the content is actually pertinent and worthy of actual concentrated study. Systems such as the COGI® system produced by the owner of this disclosure provide tools to identify and extract important portions of A/V content to save user time and effort. Further levels of content analysis and information extraction may be beneficial and desirable to users.

### SUMMARY

Example embodiments described herein have innovative features, no single one of which is indispensable or solely responsible for their desirable attributes. Without limiting the scope of the claims, some of the advantageous features will now be summarized.

In some embodiments, a content extraction and display process may be provided. Such a process may include various functionality for segmenting content into analyzable portions, ranking relevance of content within such segments and across such segments, and displaying highly ranked extractions in Graphical Cloud form. The Graphical Cloud in some embodiments will dynamically update as the content is played back, acquired, or reviewed. Extracted elements maybe in the form of words, phrases, non-verbal visual elements or icons as well as a host of other information communicating data objects compatible with graphical display.

In this disclosure, Cloud Elements are visual components that make up the Graphical Cloud, Cloud Lenses define the set of potential Cloud Elements that may be displayed, and Cloud Filters define the ranking used to prioritize which Cloud Elements are displayed.

A process may be provided for extracting and displaying relevant information from a content source, including: acquiring content from at least one of a real-time stream or a pre-recorded store; specifying a Cloud Lens defining at least one of a segment duration or length, wherein the segment comprises at least one of all or a subset of at least one of a total number of time or sequence ordered Cloud Elements; applying at least one Cloud Filter to rank the level of significance of each Cloud Element associated with a given segment; constructing at least one Graphical Cloud comprising a visualization derived from the content that is comprised of filtered Cloud Elements; and, scrolling the Cloud Lens through segments to display the Graphical Cloud of significant Cloud Elements.

In one embodiment, Cloud Elements may be derived from source content through at least one of transformation or analysis and include at least one of graphical elements including words, word phrases, complete sentences, icons, avatars, emojis, representing words or phrases at least one of spoken or written, emotions expressed, speaker's intent, speaker's tone, speaker's inflection, speaker's mood, speaker change, speaker identifications, object identifications, meanings derived, active gestures, derived color palettes, or other material characteristics that can be derived through analysis of the source content or transformational content. In another embodiment, scrolling may be performed through segments, where segments are defined by either consecutive or overlapping groups of Cloud Elements.

In one embodiment, Linked Cloud Elements may be constructed automatically by the system or configured by the media content producer to allow these Linked Cloud Elements to establish one or more connections between the user and any number of external resources, including websites, specific web pages, documents, files, images, and text. In another embodiment, Linked Cloud Element external resources may connect with specific website links (URLs) via Internet-based advertising systems, allowing for the display of media content driven, context relevant advertising for display within the Graphical Cloud visualization.

In one embodiment, Cloud Filters may include at least one of Cloud Element frequency including number of occurrences within the specified Cloud Lens segment, the number of occurrences across the entire content sample, word weight, complexity including number of letters, syllables, etc., syntax including grammar-based, part-of-speech, keyword, terminology extraction, word meaning based on context, sentence boundaries, emotion, or change in audio or video amplitude including loudness or level variation. In another embodiment, the content may include at least one of audio, video or text. In one embodiment, the content is at least one of text audio, and video, and the audio/video is transformed to text, using at least one of transcription, automated transcription or a combination of both.

In another embodiment, transformations and analysis may determine at least one of Element Attributes or Element Associations for Cloud Elements, which support the Cloud Filter ranking of Cloud Elements including part-of-speech tag rank, or when present, may form the basis to combine multiple, subordinate Cloud Elements into a single compound Cloud Element. In one embodiment, text Cloud Elements may include at least one of Element Attributes comprising a part-of-speech tag including for English language, noun, proper noun, adjective, verb, adverb, pronoun, preposition, conjunction, interjection, or article.

In another embodiment, text Cloud Elements may include at least one of Element Associations based on at least one of a part-of-speech attribute including noun, adjective, or adverb and its associated word Cloud Element with a corresponding attribute including pronoun, noun or adjective. In one embodiment, Syntax Analysis to extract grammar based components may be applied to the transformational output text comprising at least one part-of-speech, including noun, verb, adjective, and others, parsing of sentence components, and sentence breaking, wherein Syntax Analysis includes tracking indirect references, including the association based on parts-of-speech, thereby defining Element Attributes and Element Associations.

In another embodiment, Semantic Analysis to extract meaning of individual words is applied comprising at least one of recognition of proper names, the application of optical character recognition (OCR) to determine the corresponding text, or associations between words including relationship extraction, thereby defining Element Attributes and Element Associations. In one embodiment, Digital Signal Processing may be applied to produce metrics comprising at least one of signal amplitude, dynamic range, including speech levels and speech level ranges (for audio and video), visual gestures (video), speaker identification (audio and video), speaker change (audio and video), speaker tone, speaker inflection, person identification (audio and video), color scheme (video), pitch variation (audio and video) and speaking rate (audio and video).

In another embodiment, Emotional Analysis may be applied to estimate emotional states. In one embodiment, the Cloud Filter may include: determining an element-rank factor assigned to each Cloud Element, based on results from content transformations and Natural Language Processing analysis, prioritized part-of-speech Element Attributes from highest to lowest: proper nouns, nouns, verbs, adjectives, adverbs, and others; and applying the element-rank factor to the frequency and complexity Cloud Element significance rank already determined for each word element in the Graphical Cloud.

In another embodiment, the process may further include implementing a graphical weighting of Cloud Elements, including words, word-pairs, word-triplets and other word phrases wherein muted colors and smaller fonts are used for lower ranked elements and brighter colors and larger font schemes for higher ranked elements, with the most prominent Cloud Elements based element-ranking displayed in the largest, brightest, most pronounced graphical scheme. In one embodiment, as the Cloud Lens is scrolled through the content, the segments displayed may be at least one of consecutive, with the end of one segment is the beginning of the next segment, or overlapping, providing a substantially continuous transformation of the resulting Graphical Cloud based on an incrementally changing set of Cloud Elements depicted in the active Graphical Cloud.

In another embodiment, the process may further include combining a segment length defined by the Cloud Lens with a ranking criterion for the Cloud Filter to define the density of Cloud Elements within a displayed segment. In one embodiment, the Cloud Filter may include assigning highest ranking to predetermined keywords. In another embodiment, predetermined visual treatment may be applied to display of keywords. In one embodiment, each element displayed in the Graphical Cloud may be synchronized with the content, whereby selecting a displayed element will cause playback or display of the content containing the selected element.

In one embodiment the Cloud Filter portion of the process includes determining an element-rank factor assigned to each Cloud Element, based on results from content transformations including automatic speech recognition (ASR) confidence scores and/or other ASR metrics for audio and video based content; and applying the element-rank factor to the Cloud Element significance rank already determined for each word element in the Graphical Cloud.

In some embodiments, Linked Cloud Elements may be derived from Cloud Elements within the Graphical Cloud, wherein links are established between the Cloud Element and other external resources, including generalized web links (URLs), web links (URLs) to an advertising system for displayable ad content, files, images, and text. Linked Cloud Elements may reference accessible content to other Cloud Elements and to other Graphical Clouds.

In some embodiments, links may be derived through analysis of the source content or transformational content. For example, once content has been transcribed, at least one of semantic analysis, keyword detection and pattern recognition techniques may determine if a particular phrase or segment of the content at least one of comprises a link or points to a link.

In some embodiments, a URL construction may be identified by detecting any combination of URL terms including the @ symbol or “.domain” constructions. Other key words such as “website”, “Internet”, “Instagram account” or the like may be used to trigger semantic analysis of adjacent content to determine if a link has been provided or pointed to. Key words including “website”, “Internet”, or “Instagram account” may also trigger semantic analysis of adjacent content to determine if a link has at least one of been provided or pointed to.

In some embodiments, the system may be configured to support metadata from content creators including linking instructions, wherein the system will detect the instruction, suppress the instructive content, and display the link in the appropriate location to the user.

In some embodiments supporting advertisement, a process including Linked Cloud elements may further include: providing a list of information for all Cloud Elements from the Graphical Cloud to one or more Ad Networks; and, the Ad Networks interfacing with one or more Advertisers to correlate available List data and Advertiser data to construct and display Ad information from the Advertiser to the Ad Network for delivery to and incorporation by as part of the Graphical Cloud visualization. In some embodiments, information provided by the Ad Networks, in cooperation with the Advertisers, to the Graphical Cloud may be used for the selection and promotion of Cloud Elements to Linked Cloud Elements within the Graphical Cloud visualization.

In some embodiments, user input may be accepted to determine that a Cloud Element is Linked Cloud Element, and user selected Cloud Elements may be linked to an external resource. User input may take the form of a Cloud Element being selected by a user by the system accepting user commands such as clicking on a Cloud Element. In some of these embodiments, the external resource is a search engine, and linking the Cloud Element to the search engine results in display of one more entries found by the search engine related to the selected Cloud Element.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 illustrates an example flow diagram of a Graphical Cloud system.

FIG. 2 illustrates an example Graphical Cloud derived from the teachings of the disclosure.

FIG. 3 illustrates an example non-English Graphical Cloud derived from the teachings of the disclosure.

FIG. 4 illustrates example Cloud Elements.

FIG. 5 illustrates an example video display of a Graphical Cloud.

FIG. 6 illustrates an alternative example video display of a Graphical Cloud.

FIG. 7 illustrates an example audio display of a Graphical Cloud.

FIG. 8 illustrates an example time sequencing of Graphical Cloud display as content is played, reviewed, or acquired.

FIG. 9 illustrates an example Graphical Cloud with Linked Cloud Elements.

FIG. 10 illustrates example external resources for a sample Linked Cloud Element.

FIG. 11 illustrates an exemplary embodiment where user input is accepted to designate Cloud Elements as Linked Cloud Elements.

FIG. 12 illustrates an example Ad Network interface for automatic promotion of Cloud Elements into Linked Cloud Elements.

### DETAILED DESCRIPTION OF ILLUSTRATIVE EMBODIMENTS

Generally, the embodiments described herein are directed toward a system to create an interactive, graphical representation of content through the use of an appropriately configured lens and with the application of varied, functional filters, resulting in a less noisy, less cluttered view of the content due to the removal or masking of redundant, extraneous and/or erroneous content. The relevance of specific content is determined in real-time by the user, which allows that user to efficiently derive value. That value could be extracting the overall meaning from the content, identification of a relevant portion of that content for a more thorough review, a visualization of a “rolling abstract” moving through the content, or the derivation of other useful information sets based on the utilization of the varied lens and filter embodiments.

It is understood that the following description of the various elements that work together to produce the results disclosed herein are implemented as program sequences and/or logic structures instantiated in any combination of digital and analog electronics, software executing on processors, and user/interface display capability commonly found in electronic devices such as desktop computers, laptops, smartphones, tablets and other like devices. Specifically the processes described herein may be implemented as modules or elements that may be a programmed computer method or a digital logic method and may be implemented using a combination of any of a variety of analog and/or digital discrete circuit components (transistors, resistors, capacitors, inductors, diodes, etc.), programmable logic, microprocessors, microcontrollers, application-specific integrated circuits, or other circuit elements. A memory configured to store computer programs or computer-executable instructions may be implemented along with discrete circuit components to carry out one or more of the methods described herein. In general, digital control functions, data acquisition, data processing, and image display/analysis may be distributed across one or more digital elements or processors, which may be connected, wired, wirelessly, and/or across local and/or non-local networks.

### Glossary of Terms

Content. Content can include various multimedia sources including, but not limited to, audio, video and text-based media. Content can be available via a streaming source for real-time use, or that content can be already available for use.
Graphical Cloud. Graphical Clouds are visualizations derived from the content that are comprised of various Cloud Elements (e.g. words, phrases, icons, avatars, emojis, etc.) depicted in a user-friendly manner, removing irrelevant, lower priority or lower ranking elements based on the defined and selected Cloud Filters. Cloud Filters and Cloud Lenses control the types, quantity, and density of Cloud Elements depicted in the Graphical Cloud. In different embodiments and for select media types, the Graphical Cloud variations represent changes in content displayed to the user over time or sequence, and that time period or sequence length can vary and can be either segmented or overlapped.
Cloud Analysis. Cloud Analyses are techniques applied to the source content or other derived content based on transformation (i.e. transformational content) of the source content. For example, transformational analysis such as automatic speech recognition applied to the source audio content produces words, where these words are examples of transformational content. This transformation content can be source material for subsequent analysis (e.g. natural language processing of the transformational content, the words, in order to extract the parts-of-speech for each word). Example techniques include natural language processing, computational linguistic analysis, automatic language translation, digital signal processing, and many others. These techniques extract elements, attributes and/or associations forming new Cloud Elements, Element Attributes, and/or Element Associations, which may include links to external resources, for compound Cloud Elements.
Cloud Element. Cloud Elements are derived from source content through some level of transformation or analysis and include graphical elements such as words, word phrases, complete sentences, icons, avatars, emojis, to name a few, representing words or phrases spoken or written, emotions or sentiments expressed, speaker's or actor's intent, tone or mood, meanings derived, speaker or actor identifications, active gestures, derived color palettes, or other material characteristics that can be derived through analysis of the source content. Compound Cloud Elements are a collection of Cloud Elements, constructed based on the Element Attributes and Element Associations linking these subordinate Cloud Elements within that collection.
Linked Cloud Element. Linked Cloud Elements are Cloud Elements that may interact with other Graphical Cloud content (e.g. content from the same or other Graphical Clouds) or other external resources, including generalized web links (URLs), documents, files, images, text or other associated content that may or may not be associated with the Graphical Cloud that contains this specific Linked Cloud Element. Linked Cloud Elements may associate with Graphical Clouds based on any number of technical metrics including relevance to the specific content of the Graphical Cloud that the given Linked Cloud Element is contained within.
Cloud Filter. Cloud Filters provide the user with the control to select one or multiple Cloud Element sets, as extracted from the source material via Cloud Analysis, for consumption, based on specific input parameters and/or algorithmically defined heuristics. Cloud Filter types are numerous, including element frequency (number of occurrences within the specified Cloud Lens reference or frame of view, or the number of occurrences across the entire content sample), word weight and/or complexity (number of letters, syllables, etc.), syntax (grammar-based, part-of-speech, keyword or terminology extraction, word meaning based on context, sentence boundaries, etc.), emotion (happy, sad, angry, etc.), and dynamic range (loudness or level variation), to name a few. Cloud Filters are not limited in their function to the Cloud Elements defined within a specific view as defined by the Cloud Lens. Rather, the scope of the Cloud Filter can be “local” to the specific Cloud Lens view, or the scope of the Cloud filter can be “global” across all of the Cloud Elements derived or extracted from the selected content. This enables the Cloud Filter to properly prioritize (rank) a specific Cloud Element that has significance elsewhere in the overall (global) content sample.
Cloud Lens. Cloud Lenses provide controlled views into the content, impacting the viewed density and magnification level of a Graphical Cloud for a given visualization. In some embodiments, the Cloud Lens defines a magnification level of the content representing a fixed time period or sequence length for the construction of the Graphical Cloud. The Cloud Lens bounds the amount of content under consideration for subsequent prioritization and ranking of the potentially displayable Cloud Elements. The Cloud Lens controls the period of time or quantity of media samples to be used for display. In the case of text-based content, the Cloud Lens controls the quantity of text or content sequence length (e.g. number of words, sentences, paragraphs, chapters, etc.) to be used for Cloud Filter assessment and ranking.
Element Attribute. Cloud Elements may have additional attributes assigned to them. For example, a transcript of an audio sample would produce a set of word elements, and each of these words could be assigned the appropriate part-of-speech (e.g. noun, pronoun, proper noun, adjective, verb, adverb, etc.) for that specific word in that specific context, as some words can have different meanings and additional attributes in different contexts. Digital signal processing analysis could be performed on audio or video content to determine the variation in amplitude of the audio over a series of words or time period, defining an attribute for those Cloud Elements. Analysis, transformation, or user interaction can augment a Cloud Element to add an attribute, e.g. like part-of-speech is an attribute.
Element Association. Cloud Elements may have associations with other Cloud Elements or other external resources not direction contained within a Graphical Cloud embodiment. Examples include a word element that has an adjective attribute and its associated word element with a noun attribute. Another example includes an emotional element attribute (“inquisitive”) that may reference the associated word, word phrase or sentence (e.g. a question). Another example includes external resources, including URLs, files, images, text, or advertisements can be associated with Cloud Elements, transforming that Cloud Element into a Linked Cloud Element. If a Cloud Element has an Element Association that is a web link (URL) to a specific ad link, then that Cloud Element could be displayed in a new manner, resulting in ads incorporated within the visual display. Semantic Analysis, transformation, or user interaction can augment a Cloud Element to add, or in some cases detect, an association, e.g. like a web link (URL) to a website or document.
Visual Noise. Visual Noise references that, for any specific source of content, only a relatively small percentage of derived Cloud Elements (e.g. words, icons, etc.) are valuable for a given user visual interaction. For example, an hour of audio or video content for a normal speaking rate of 150 to 230 words-per-minute (wpm) represents 9,000 to 14,000 words for that media sample, and the number of important (high ranking) words or keywords from that sample is but a fraction of the total. With the additionally extracted Cloud Elements (e.g. speakers, speaker changes, gestures, emotions, etc.) from that same content sample, the number of potentially redundant, extraneous or erroneous, and therefore not useful, graphical elements can be significant.

Graphical Cloud Construction

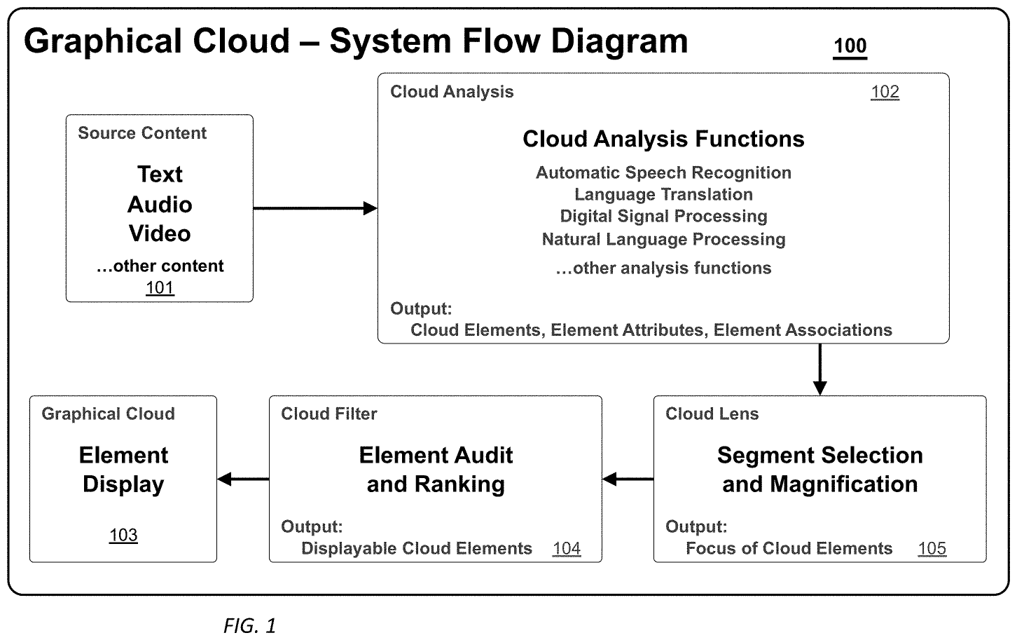

The system 100 is comprised of the primary subsystems as depicted in the system flow diagram FIG. 1. Source content 101 is submitted to Cloud Analysis 102, where transformational analyses are performed on the input content, producing a complete set of Cloud Elements, their Element Attributes, and their Element Associations to other Cloud Elements. Further, compound Cloud Elements are constructed based on the Cloud Elements and any Element Attributes and Element Associations.

The logical flow of media and extraction of valuable content follows the following process:
Source content 101 is presented to the Cloud Analysis module 102, which may, if necessary, transform the content into text (e.g. words, phrases and sentences via Automatic Speech Recognition technology), transform the content into a target language (e.g. words, phrases and sentences via language translation technology), or extract varied metadata from the source content (e.g. part-of-speech, speaker change, pitch increase, etc.).
The words and other metadata produced by the Cloud Analysis module either define a Cloud Element, an Element Attribute, or an Element Association. The Cloud Analysis module can be considered a pre-filter that extracts and transforms the source content into these base units for subsequent analysis and processing.
The output of the Cloud Analysis 102 module is presented to the Cloud Lens 105, which determines the subset of Cloud Elements under consideration for eventual graphical visualization. Only Cloud Elements within the time window or segment defined by the Cloud Lens can be displayed in the Graphical Cloud. Further, a focus weight may be applied to the Cloud Elements to apply a larger weight to Cloud Elements in the center of the Cloud Lens as compared to the Cloud Elements that are closer to the edge of the local, lens view. The focus weight of each Cloud Element contributes to the eventual element weight or ranking as determined by the Cloud Filter.
Integrated within Cloud Analysis, manual or human-generated transcripts can be enhanced with automatic speech recognition (ASR) to produce very accurate timing for these human-generated solutions, thereby insuring that any type of transcript can be accurately synchronized to the media for subsequent transformation and analysis to construct interactive Graphical Clouds.
The Cloud Elements with associated focus weights and other metadata (e.g. part-of-speech attribute, etc.) are presented to the Cloud Filter 104, which applies rules to assess and establish each Cloud Element's rank or weight. The Cloud Filter also determines based on Element Attributes and Element Associations what constitutes a compound Cloud Element and assigns a rank to the compound Cloud Element as well. The output of the Cloud Filter is a ranked and therefore ordered list of Cloud Elements, including compound Cloud Elements, all of which are presented to the element display 103 for the construction of the Graphical Cloud visualization.
Although the Cloud Lens 105 specifies a subset of Cloud Elements for analysis and ranking by the Cloud Filter 104, the Cloud Filter also retains access to the complete set of Cloud Elements from the input source content in order to further tune the Cloud Element ranking within the segment or time window. This global context of all Cloud Elements allows the Cloud Filter to assess the frequency of occurrence of specific Cloud Elements when determining specific rank. For example, if a specific word occurs just once in a given Cloud Lens segment yet has a high frequency of occurrence throughout the media sample, the relative weight applied to that specific word Cloud Element would be higher than it would be if only the local context was considered.
The Graphical Cloud 103 is comprised of a subset of Cloud Elements, including compound Cloud Elements, limited by the Cloud Lens 105 with further visual emphasis placed on the elements within this collection that have the highest-rank.
The Graphical Cloud 103 takes into consideration the Cloud Lens 105 view defining the allowable density of visual components, the underlying language rules that define reading orientation, which for English is left-to-right and top-to-bottom. For example, a word that is determined to be relevant to the content, either locally within the Cloud Lens view or globally across the entire content sample, may be displayed in a brighter and larger font (for text) or a larger graphical element (e.g. icons, avatars, emoji, etc.).
The content is synchronized such that each element from the Graphical Cloud 103 is tied to the specific content or media location for detailed review, and in the case of audio and video, synchronized playback. Synchronization works in both directions, as the user can access the audio waveform, video playback progress bar, or the text-based content to index within the varied time ordered and segmented Graphical Clouds. The user can also access the Graphical Cloud elements to begin playback of the media, for audio and video content, or to appropriately index into the text-based content.

Cloud Analysis Functions

The following is a partial list of transformational processes and analysis techniques can be applied to the varied content sources to produce compelling Cloud Elements, including their Element Attributes and Element Associations:
Automatic Speech Recognition (ASR)
Language Translation
Natural Language Processing (NLP)
Natural Language Understanding
Computational Linguistics (CL)
Cognitive Neuroscience
Cognitive Computing
Artificial Intelligence (AI)
Digital Signal Processing (DSP)
Image Processing
Pattern Recognition
Optical Character Recognition (OCR)
Optical Word Recognition

Limitations on the performance (e.g. accuracy) of these analysis techniques play a significant role in the extraction, formation, and composition of Cloud Elements. For example, Automatic Speech Recognition (ASR) systems are measured on how accurate the transcript matches the source content. Conditions that significantly impact ASR performance, as measured by its word error rate, include speaker's accent, crosstalk (multiple speakers talking at once), background noise, recorded amplitude levels, sampling frequency for the conversion of analog audio into a digital format, specific or custom vocabularies, jargon, technical or industry specific terms, etc. Modern ASR systems produce confidence or accuracy scores as part of the output information produced, and these confidence scores remain as attributes for the resulting Element Clouds and impact the significance rank produced by the Cloud Filter.

Cloud Lens, Window, Sequence, Perspective and Density

The Cloud Lens provides a specific view into the media, defining a specific magnification level into the entire source content. Fully expanding the Cloud Lens allows the user to view a Graphical Cloud for the entire content sample (e.g. a single Graphical Cloud for an entire 90-minute video). Magnification through the Cloud Lens allows the user to view a Graphical Cloud that represents only a portion or segment or the entire content sample. These segments can be of any size. Further segments can be consecutive, implying the end of one segment is the beginning of the next segment. Or, segments can be overlapping, allowing for a near continuous transformation of the resulting Graphical Cloud based on an incrementally changing set of Cloud Elements depicted in the actively displayed Graphical Cloud.

Combine the magnification setting as defined by the Cloud Lens with the complexity and controls defined by the Cloud Filter and the “density” of Cloud Elements within a specified segment is defined. This level of control allows the user to determine how much content is being displayed at any given time, thereby presenting an appropriate level of detail or relevance for each specific use case.

Cloud Filter, Eye Fixation, Skimming and Reading Speeds

A significant consideration for construction of the Graphical Cloud and element-ranking algorithm used within the Cloud Filter is that the human eye can see, in a single fixation, a limited number of words, and some studies indicate that for most people, the upper bound for this eye fixation process is typically three words, although this limit varies based on a person's vision span and vocabulary. Thus, there is a benefit to keep important word phrase length limited and to maintain or develop Element Attributes and Associations allowing for word-pairs (element-pairs) and word-triplets (element-triplets) to be displayed in the Graphical Cloud when these rank high enough within the specific Cloud Filter's design. In some views defined by the Cloud Lens, the Cloud Filter will only display isolated Cloud Elements. But when that Cloud Lens extends the view sufficiently, there is a significant, positive impact on understanding and value from the inclusion of compound Cloud Elements as ranked by the Cloud Filter.

Understanding the effects of human perception and eye fixation helps in designing effective Cloud Filters, as the goal of the Graphic Cloud is the ability to efficiently scan for relevant element clusters, with that relevancy dependent on the specific needs of that user. Maintaining element associations and displaying the correct number of elements that fit within the bounds of what people are able to immediately view increases identification and interpretation speeds. With the techniques disclosed herein, a significant reduction in Visual Noise (i.e. visual element clutter), with appropriate visual spacing for optimal eye tracking, and with the value of reading multiple elements (words or other element types) in a single eye fixation, can lead to even greater efficiencies for the user to extract value from the content.

Cloud Filter Embodiment via Frequency, Complexity and Grammar-Derived Attributes

A representative Cloud Filter includes tracking a variety of parameters derived from varied analyses. An example Cloud Filter includes, for text-based content or text derived from other content sources, a word complexity and frequency determination and a first-order grammar-based analysis. From each of these processes, each element in the Graphical Cloud is given an element-rank. From that rank, the user display is constructed highlighting the more relevant elements extracted from the content.

A sample word-word-phrase-element-ranking analysis can be constructed by determining word complexity and frequency of occurrence of each word and word phrase within the specific Graphical Cloud segment or across the entire media sample. Word complexity can be as simple as a count of the number of letters or syllables that make up the specific word. Element-rank is directly proportional to the complexity of a given element or the frequency of occurrence of that element. Any filter metric can be considered “local” to just the segment or “global” if it references content analyzed across the entire media sample.

A first-order grammar-based analysis can be performed on the text content to determine parts-of-speech. An example algorithm is described that could be used to construct the appropriate Cloud Elements to be used by the Cloud Filter:
Analyze text to determine parts-of-speech, including for the English language: noun, verb, article, adjective, preposition, pronoun, adverb, conjunction and interjection. Extensive linguistic work provides many more separate parts of speech. This analysis is also different for other languages, so language-specific determination of parts-of-speech is relevant to one type of Cloud Filter.
Add an element-rank factor to each word based on part-of-speech. For example, for the English language, a noun is often the centerpiece for each sentence, and as such, an incremental increase in element-rank applied when compared to element-rank for other parts of speech. This part-of-speech rank would be an attribute of the specific word defined base on the output of the Cloud Analysis.
The part-of-speech rank differs for each part of speech and is prioritized. For the English language, the following is one prioritized order, from highest to lowest: proper nouns, nouns, verbs, adjectives, adverbs, others. These attributes, defined during Cloud Analysis, and utilized in the element ranking by the Cloud Filter.
In the same way, parts-of-speech can provide attributes that augment an object, other parts-of-speech can provide attributes that augment the action being taken, another attribute, or yet other parts-of-speech. For the English language, these are adverbs, and they qualify an adjective, verb, other adverbs, or other groups of words. The determination of the association between these “adverb” parts-of-speech can be useful in the construction of a compound Cloud Element and its visualization.
Apply the attribute-rank factor to the frequency and complexity rank already determined for each Cloud Element in the Graphical Cloud.
Based on the Cloud Lens, determine the active window into the content, determine the density of Cloud Elements to be displayed. Based on the Cloud Filter, determine the element-rankings and derived component Cloud Elements, and construct the visual Graphical Cloud.
Based on key Element Associations for highly ranked Cloud Elements, associated elements can be displayed even when the element-ranking for that associated element is not sufficiently high enough for the given display.
To support enhanced visual comprehension of displayed Cloud Elements, a graphical weighting of these elements is implemented, including the following element types: words, word-pairs, word-triplets and any other word phrases displayed. For example, muted colors and smaller fonts are used for adjectives and adverbs as compared to the brighter color and larger font schemes for the nouns and verbs that they reference. The most prominent Cloud Elements based element-ranking are displayed in the largest, brightest, most pronounced graphical scheme.
A further visual enhancement for highly-prioritized word elements is to have increasing or decreasing font size within a specific word to reflect other signal processing metrics. For example, increasing or decreasing pitch can determine font size changes within specific words or phrases.

The following sentence demonstrates the value of understanding core grammatical parts-of-speech for the construction of Cloud Elements, which in turn, are displayed appropriately, and potentially differently, based on specific filter parameters. Cloud Elements are displayed based to the nature of the Cloud Filter and inputs to the system in terms of “element density” for a given visualization. The following English-language sentence depicts valuable content for construction of a compound Cloud Element and consumption of that Cloud Element by the Cloud Filter:
John Williams could not complete the task because of his tremendously heavy workload.

From the reference sentence above, the nouns are “John”, “Williams”, “task” and “workload”. As such, each will have a high element-rank for the example Cloud Filter embodiment. The verb “complete” is next in level of importance or rank. Adverb “tremendously” and adjective “heavy” are equally ranked and lower than nouns and verbs. However, each has an association, “tremendously” to “heavy” and “heavy” to “workload”. These associations form the compound Cloud Element, composed of three subordinate Cloud Elements associated with the phrase “tremendously heavy workload”.

As such, the compound Cloud Element “tremendously heavy workload” could be displayed together in one filter embodiment, given the Cloud Lens state, to produce a more meaningful display to the user as compared to the single, important noun “workload”. Further, eye fixation is defined by the fact that humans can often see multiple words for a given instantaneous view of the content. As such, the user can potentially interpret “tremendously heavy workload” in a single view (eye fixation), thereby increasing the relevance of the display.

This algorithm can be extended in numerous ways as more and more analytical functions are applied to the content to create more Cloud Elements, with corresponding Element Attributes and Element Associations. Further extensions can be applied as new element types (e.g. gestures, emotions, tone, intent, amplitude, etc.) are constructed, adding to the richness of a Graphical Cloud visualization.

Graphical Cloud Composition

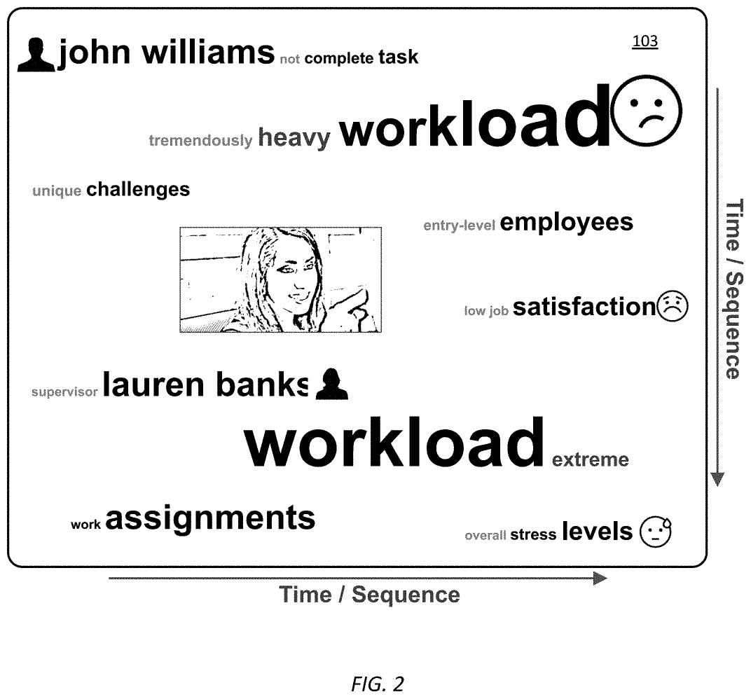

The Graphical Cloud 103 is constructed over a given period of time or sequence of the content, as selected by the user. FIG. 2 depicts a transformation and graphical display 103 of the Graphical Cloud representation derived from the sample content. The resulting Graphical Cloud for this example depicts Cloud Elements that are words, phrases, icons, select persona or avatars, emotional state (emoji), as well as Element Attributes and Element Associations that combine individual Cloud Elements into compound Cloud Elements (e.g. word-pairs, word-triplets, etc.), and Cloud Attributes (e.g. proper nouns) to appropriately rank the Cloud Elements, as defined by the Cloud Filter.

FIG. 2. depicts a Graphical Cloud constructed from the following example text:
“John Williams could not complete the task because of his tremendously heavy workload.
This is another example of the unique challenges for entry-level employees, leading to low job satisfaction.
His supervisor, Lauren Banks, provides guidance, yet her workload is extreme too.
Management needs to review work assignments given overall stress levels!”

Consider this time or sequence a level of magnification or zoom into the content. For example, the magnification or zoom level could represent 5 minutes of a 60-minute audio or video sample. Independent of this “zoom level” is the word density of the specific Graphical Cloud, all configured and controlled by the Cloud Lens and Cloud Filter. That is, for a given media segment (i.e. 5 minutes of a 60 minute media file), the number of elements (e.g. words) displayed within that segment can vary, defining the element density for that given Graphical Cloud view.

Graphical Cloud Translation

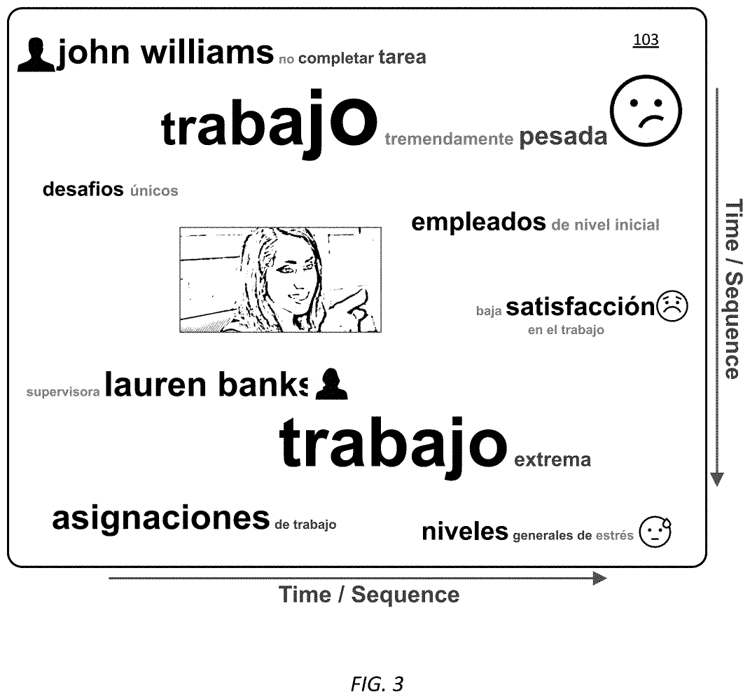

Language translation solutions can be applied to the source content, either the output of an automatic speech recognition system applied to the source audio or video content or to an input sourced transcript of the input audio or video content. The output of the language translation solution is then applied to other Cloud Analysis modules, including the use of natural language processing in order to determine appropriate word order within the compound Cloud Element. The output of this process is depicted in FIG. 3 showing Graphical Cloud display 103, highlighting the language translation application with appropriate Spanish translation and word order.

FIG. 3. depicts a Graphical Cloud constructed from the following, translated example text:
“John Williams no pudo completar la tarea debido a su carga de trabajo tremendamente pesada.
Este es otro ejemplo de los desafios finicos para los empleados de nivel inicial, que conduce a una baja satisfaccion en el trabajo.
Su supervisora, Lauren Banks, proporciona orientacion, pero su carga de trabajo es extrema tambien
La gerencia necesita revisar las asignaciones de trabajo dados los niveles generates de estres!”

The input source can be translated on a word, phrase or sentence basis, although some context may be lost when limiting the input content for translation. A more comprehensive approach is to translate the content en masse, producing a complete transcript for the input text segment, as shown in the figure. Other Cloud Analysis techniques are language independent, including many digital signal processing techniques that extract speaking rate, speech level, dynamic range, speaker identification, to name a few.

The process applied to the translated text and input source content produces the complete set of Cloud Elements, with their Element Attributes, and Element Associations. The resulting collection of compound Cloud Elements and individual Cloud Elements is then submitted to the Cloud Lens and Cloud Filters to produce the translated Graphical Cloud.

Linked Cloud Elements and Graphical Cloud Editing

Within a Graphical Cloud, a Cloud Element can have an Element Association that is a “link” to an external resource, resulting in the formation of a Linked Cloud Element. External resources include web links (URLs), documents, text, images or files of any type. These external resources can be associated with the Graphical Cloud in a variety of ways, including via a publicly accessible reference (e.g. Google Drive or Dropbox link) or uploaded directly to the system hosting the Graphical Cloud.

Element Associations can be automatically assigned to Cloud Elements by the system through the analysis and construction of the Graphical Cloud and in association with external systems that provide ancillary and relevant information. The transformations and analyses performed on the media produces Cloud Elements. In one embodiment, automatic speech recognition produces a transcript of the audio or video content. The words, word phrases and associated prioritization data constructed by the Graphical Cloud system can be exported to other systems to link advertising data for these specific Cloud Elements, transforming or promoting the Cloud Element into a Linked Cloud Element. The resulting Graphical Cloud visualization can display these content-relevant ads.

The system may also detect links automatically through other avenues compatible with the techniques described herein. For instance, once a portion of content has been transcribed, a variety of semantic analysis, keyword detection and pattern recognition techniques may be used to determine if a particular phrase or segment of the content either comprises a link or points to a link. In the simplest case, a URL construction may be identifiable by detecting any combination of URL terms such as the @ symbol, or “.domain” constructions. Other key words such as “website”, “Internet”, “Instagram account” or the like may be used to trigger semantic analysis of adjacent content to determine if a link has been provided or pointed to.

In some cases, the system may be configured to support metadata from content creators who know or suspect their content will be processed by the Graphical Cloud system at some point. The system may be configured to support linking instructions, such as “Insert URL here” or the like, and thus the system will detect the instruction, suppress the instructive content, and display the link in the appropriate location to the user.

In an implementation where content creators who source the media are also the users of the Graphical Cloud system, the creator may create a scrollable Graphical Cloud of a content item as part of the content package delivered. In this case the system can be can configured to allow the creator editing capability to the constructed Graphical Cloud to edit the automatically produced visualization. Edit functions on the Graphical Cloud for one or more Cloud Elements may include the correction of transcription errors, the modification, promotion or demotion, of rank, and the association of external resources. In the case of external resource associations, the content creator can upload ancillary media content in the form of documents, images, additional text, and other information, or can provide a publicly accessible link to that content in the form of a web link (URL) or other hosted link (e.g. Dropbox or Google Drive URLs).

User Supplied Keywords and Triggers

An alternative embodiment could include the ability to preset or provide a list of keywords relevant to the application or content to be processed. For example, a lecturer could provide keywords for that lecture or for the educational term, and these keywords could be provided for the processing of each video used in the transformation and creation of the associated Graphical Clouds. An additional example could include real-time streaming applications where content is being monitored for a variety of different applications (e.g. security monitoring applications). For each unique application in this streaming example, the “trigger” words for that application may differ and could be provided to the system to modify the Cloud Filter's element-ranking and subsequent and resulting real-time Graphical Clouds. Additionally, the consumer of the content could maintain a list of relevant or important keywords as part of their account profile, thereby allowing for an automatic adjustment of keyword content for generation of Graphical Clouds.

Keywords provided to the system can demonstrably morph the composition of the resulting Graphical Clouds, as these keywords would by definition rank highest within the constructed Graphical Clouds. Scanning the Graphical Clouds through the media piece can also be further enhanced through special visual treatment for these keywords, further enhancing the efficiency in processing media content. Note that scanning or skimming text is four to five times faster than reading or speaking verbal content, so the Graphical Cloud scanning feature adds to that multiplier given the reduction of text content being scanned. Thus the total efficiency multiplier could be as high as 10 times or more for the identification of important or desired media segments or for visually scanning for overall meaning, essence or gist of the content.

Edit distance integrated into the system can enhance use of user-defined keywords. Transcripts produced via automatic means (e.g. ASR) can have lower word accuracy, and an edit distance with a predetermined threshold (i.e. threshold on number of string operations required) can be utilized to automatically substitute an erroneous ASR output for the likely keyword, allowing for the display (or other action) of that keyword in the resulting Graphical Cloud.

As noted above, keywords may also be an indication of links to external resources.

Non Word-Based Triggers

The disclosed techniques along with Cloud Analysis have the potential to generate compelling and interesting Cloud Elements that include emotions, gestures, audio markers, etc. Extending the concept of user supplied keywords is the concept of allowing the user to indicate elements from within the source content that are relevant to their visualization need and experience. For example, scanning the Graphical Cloud for areas in the audio sample where there were large changes in audio levels, indicating a potentially engaging dialog between participants.

Graphical Cloud Component Diagram

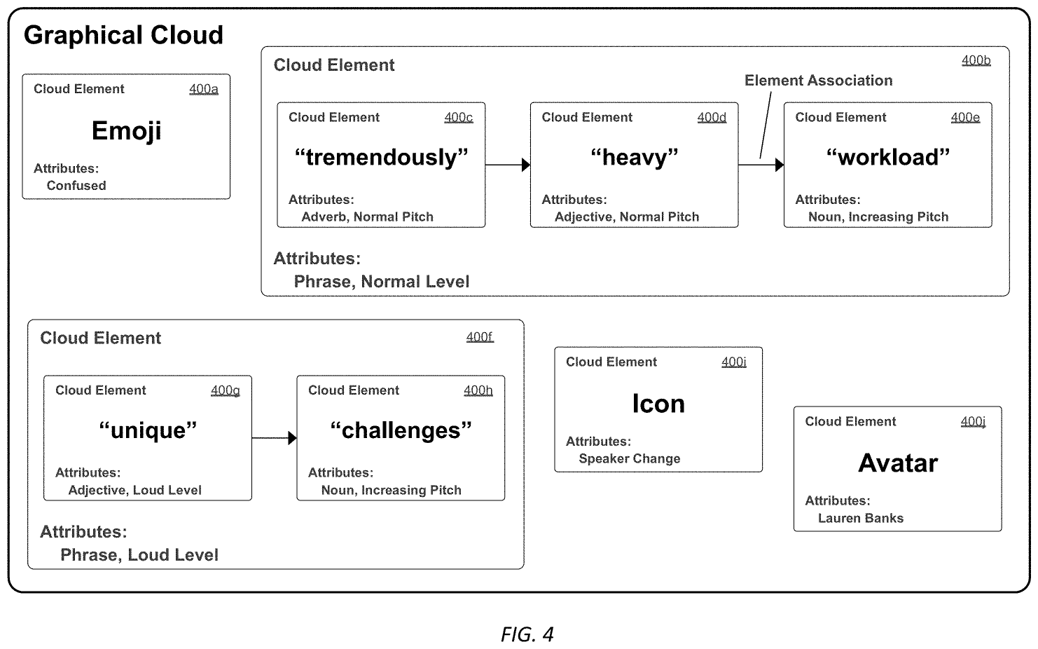

FIG. 4 depicts a representative Graphical Cloud, comprised of Cloud Elements (400a-400j) and includes compound Cloud Elements (400b and 400f), which in turn are Cloud Elements and a collection of associated Cloud Elements. Each Cloud Element can have one to many Element Attributes and one to many Element Associations, based on the varied analysis performed on the source media content (e.g. audio, video, text, etc.). As depicted, Element Attributes and Element Associations support the formation of compound Cloud Elements.

The number of Cloud Elements within a compound Cloud Element is dependent on the importance of the Element Associations in addition to the control parameters for the Cloud Filter and Cloud Lens, defining the density of Cloud Elements that are to be displayed within a given Graphical Cloud for a given time period or sequence of content. As such, the compound Cloud Element may not be depicted in a given Graphical Cloud at all, or only the primary, independent Cloud Element may be displayed, or all of the Cloud Elements may be displayed.

Example Display—Video View 1

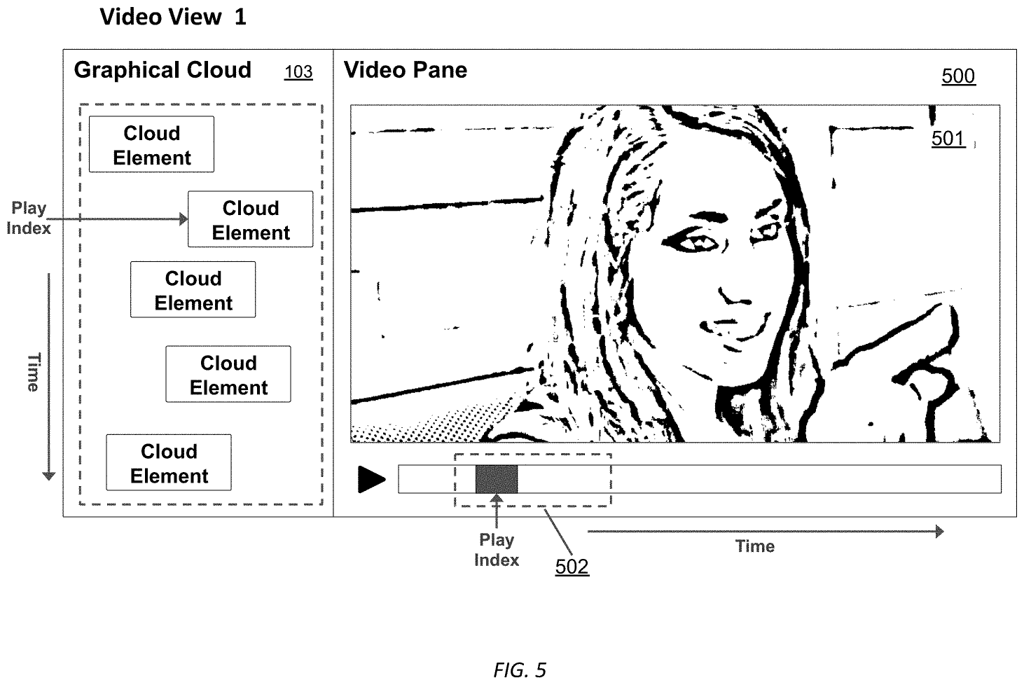

FIG. 5 depicts an example visualization (Graphical Cloud 103) with each of the major components for a video display embodiment. The video pane 500 contains the video player 501, which is of a type that is used within web browsers to display video content (e.g. YouTube or Vimeo videos). In this video pane 500, time goes from left to right. For this embodiment, as the video plays, the Graphical Cloud 103 visualization scrolls to remain relevant and synchronized to what's being displayed within the video content.

The left pane displays the constructed Graphical Cloud 103 for a selected view on the timeline for the video, and the Graphical Cloud elements are synchronized with the video content depicted in right video pane 500. The corresponding time window as represented by the Graphical Cloud view is also shown in the video pane by the dashed-line rectangle 502. The size of the video pane dashed line area is defined by the Cloud Lens 105, with settings controlled by the user relative to level of content view magnification.

Other embodiments can be extended to include tags and markers within the audio and video playback to allow the user to annotate (with tags) or mark locations already identified through scanning the Graphical Cloud, viewing the video or both.

Example Display—Video View 2

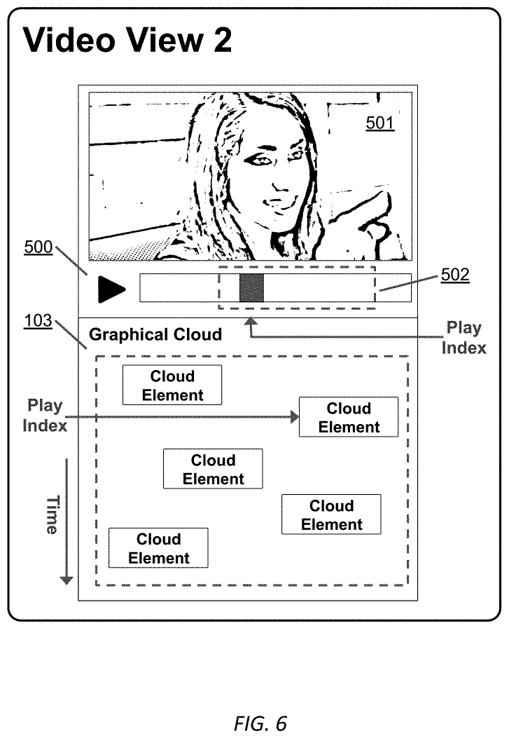

FIG. 6 depicts an example Graphical Cloud 103 of a type appropriate to a mobile video view. The video player 501 is shown at the top of the display, followed by a section for positional markers and annotation tabs. The lower portion of the view is the Graphical Cloud displaying the corresponding time for the constructed Graphical Cloud as depicted in the dashed rectangle 502.

Audio Display (View)

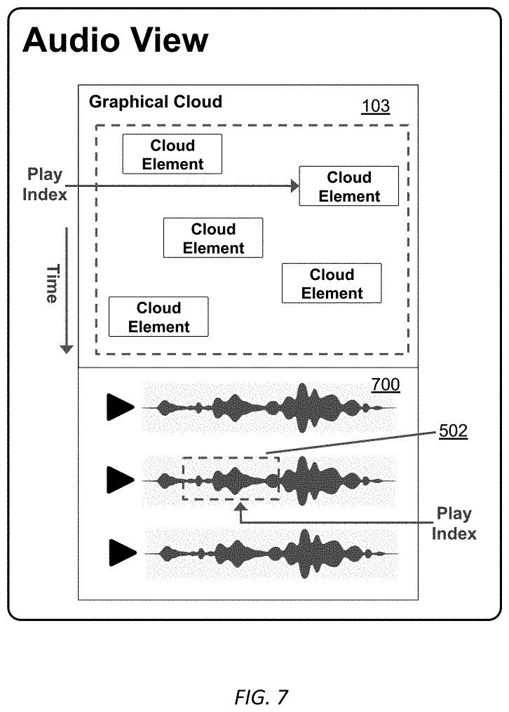

FIG. 7 depicts an example Graphical Cloud display 103 implementation, with the Graphical Cloud displayed above one or more audio waveforms 700. As with the mobile and web video views, a dashed rectangular display 502 is depicted over the waveform to show the period of time for a given Graphical Cloud display.

Time Periods & Word Density

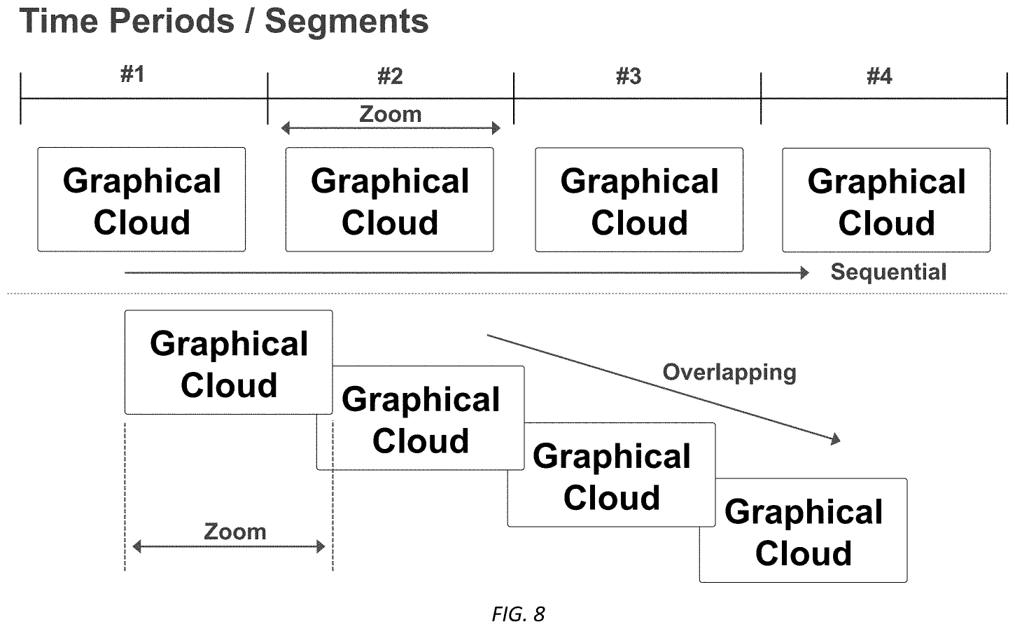

The Graphical Clouds are generated over some period of time (window) or a select sequence of content based on how the user has chosen to configure their experience. There are multiple ways to construct each specific Graphical Cloud as the user scrolls through the media content. FIG. 8 depicts two such time segment definitions, sequential and overlapping. The duration of a given segment or window is defined by the magnification or “zoom” level that the user has selected (via the Cloud Lens). For example, the user could opt to view 5 minutes or 8 minutes of audio for each segmented Graphical Cloud. The Graphical Cloud constructed for that specific 5-minute or 8-minute segment would be representative of the transcript for that period of time based on an element-ranking algorithm.

Newly constructed Graphical Clouds could be constructed and displayed en masse (sequential segments) or could incrementally change based on the changes happening within each specific Graphical Cloud (overlapping segments). Graphically interesting and compelling displays can be used to animate these changes as the user moves through the media, either by scrolling through the time associated Graphical Clouds or by scrolling through the media indexing as is typical with today's standard audio and video players.

Linked Cloud Element Display

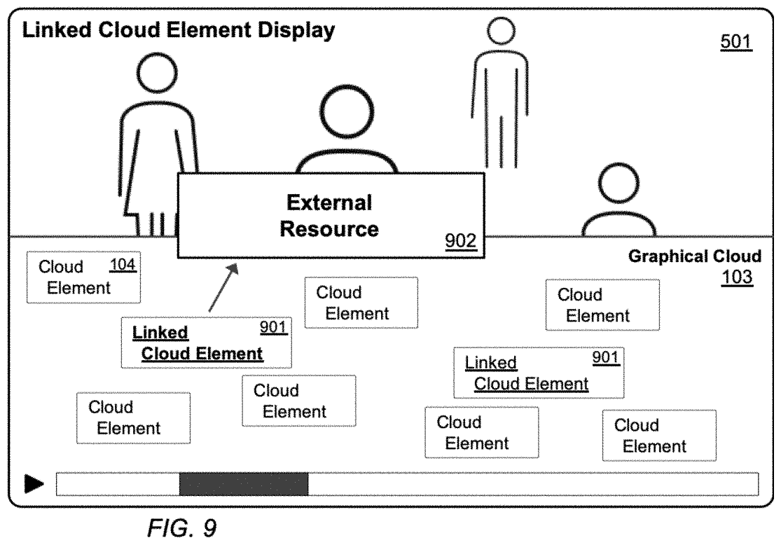

Cloud Elements 104 contained in a Graphical Cloud 103 may be linked to external resources 902 forming a Linked Cloud Element 901. FIG. 9 depicts the identification of two Linked Cloud Elements 901, one of which is displaying the connection to an external resource 902. FIG. 9 depicts an example, visually distinct representation of Linked Cloud Element 901 shown with underlined text. In one embodiment, the linked external resource content visualization could be a graphically rich visual (e.g. via the Open Graph Protocol), displaying a title, an image, and a description of the external resource data.

Linked Cloud Element External Resource Display

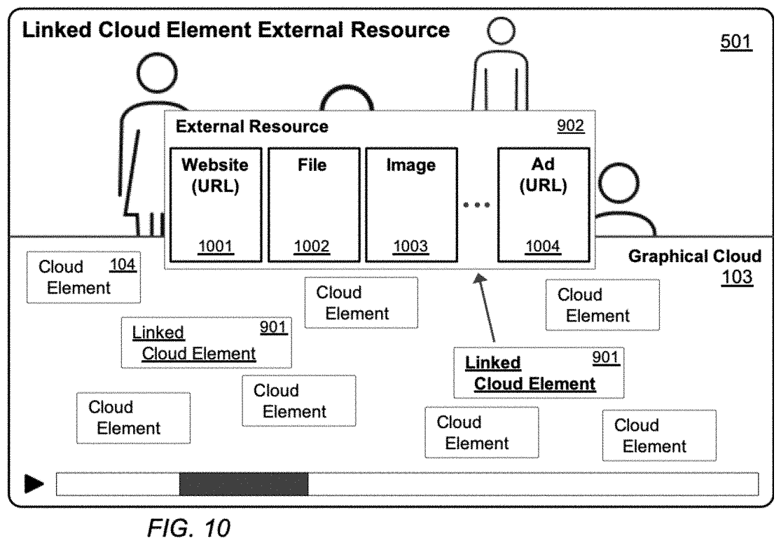

FIG. 10 depicts a Graphical Cloud 103 with numerous Cloud Elements 104 and two Linked Cloud Elements 901. This example depicts one Linked Cloud Element 901 that is referencing an external resource which may be a generalized website (URL) 1001, a file 1002, an image 1003, and a specific web URL to an Ad Network, allowing for the display of the Advertisement 1004 within the Graphical Cloud visualized display.

User Designation of Cloud Elements as Linked Cloud Elements

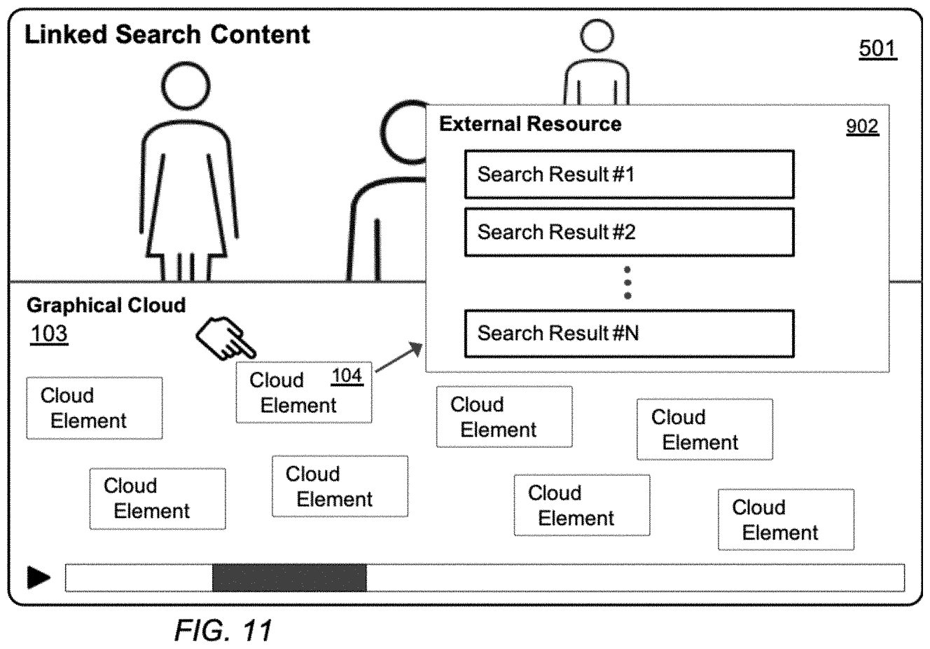

In some cases, it may be advantageous to allow a user to identify a Cloud Element as linked. An example is shown in FIG. 11. In FIG. 11 a user observing displayed Could Elements may desire further information. The system may be configured to accept user input about individual Cloud Elements 104, such as clicking on the element, mousing over, or other user selection mechanisms used in displayed data.

A user identified Cloud Element 103 becomes linked to external resources 902 according to specific system implementations. One useful example is shown in the Figure. For the case shown, the external resource 902 is a search engine, which may be accessed automatically by the system. The search engine is fed the selected Cloud Element attributes, which in the simplest case may just be the words associated with the element, and the search engine could be a common character driven engine such as Google. As shown, the search results associated with the selected Cloud Element may be displayed in the Graphical Cloud 501, and these results may in turn be linkable.

Other more complex associations may be desirable. For instance, if the selected Cloud Element is an image, the system may deliver it to an image database and results returned. In general, a user identified Cloud Element may be linked to an appropriate external resource depending on the nature of the element, and information related to the element may be returned to and, if desired, displayed in the Graphical Cloud.

Advertising Network Interface

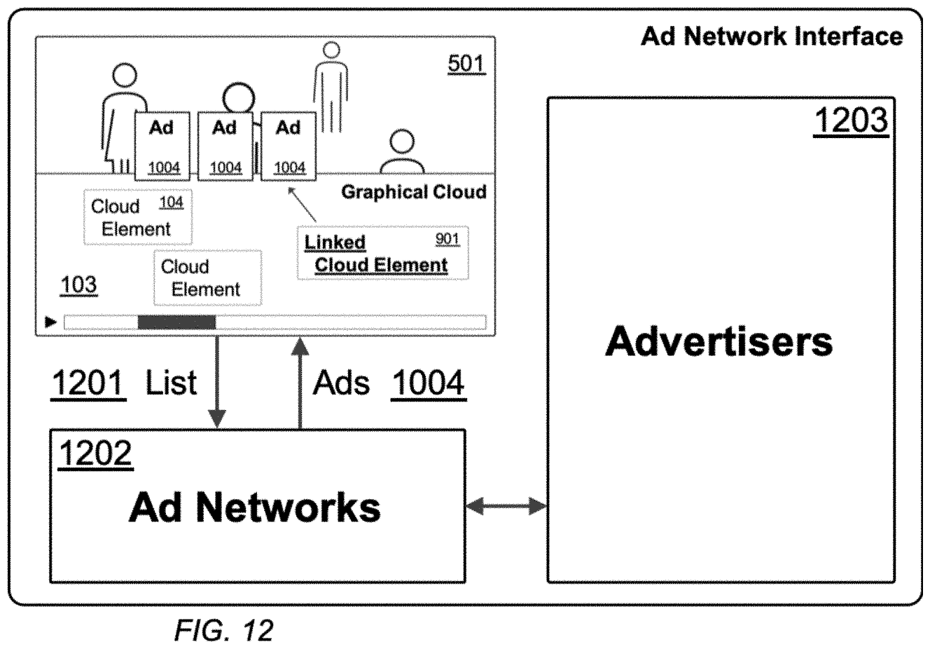

FIG. 12 depicts a Graphical Cloud 103 with Cloud Elements 104 and Linked Cloud Elements 901. A List 1201 of information for all Cloud Elements 104 from the specific Graphical Cloud 103 is provided to one or more Ad Networks 1202. These Ad Networks, in turn, interface with one or more Advertisers 1203 to correlate available List data and Advertiser data to construct and provide display Ad 1004 information from the Advertiser to the Ad Network for delivery to and incorporation by the system as part of the Graphical Cloud visualization. Specific Ad 1004 information is provided by the Ad Networks, in cooperation with the Advertisers, to the Graphical Cloud for the selection and promotion of Cloud Elements 104 to Linked Cloud Elements 901 within the Graphical Cloud visualization. This enables a visual experience to serve the specific ad to the user for a given Linked Cloud Element.

Depending on the embodiment, certain acts, events, or functions of any of the processes described herein can be performed in a different sequence, can be added, merged, or left out altogether (e.g., not all described acts or events are necessary for the practice of the process). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and process steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processor configured with specific instructions, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method or process described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. A software module can comprise computer-executable instructions which cause a hardware processor to execute the computer-executable instruction.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details processes illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

1. A process for extracting and displaying relevant information from a content source, comprising:
Acquiring content from at least one of a real-time stream or a pre-recorded store;
Specifying a Cloud Lens defining at least one of a segment duration or length, wherein the segment comprises at least one of all or a subset of at least one of a total number of time or sequence ordered Cloud Elements;
Applying at least one Cloud Filter to rank the level of significance of each Cloud Element associated with a given segment;
Constructing at least one Graphical Cloud comprising a visualization derived from the content that is comprised of filtered Cloud Elements; and,
Scrolling the Cloud Lens through segments to display the Graphical Cloud of significant Cloud Elements;
wherein Linked Cloud Elements are derived from Cloud Elements within the Graphical Cloud, wherein links are established between the Cloud Element and other external resources, including generalized web links (URLs), files, images, and text.

2. The process of claim 1, wherein Cloud Elements are derived from source content through at least one of transformation or analysis and comprise at least one of graphical elements including words, word phrases, complete sentences, icons, avatars, emojis, representing words or phrases at least one of spoken or written, emotions expressed, speaker's intent, speaker's tone, speaker's inflection, speaker's mood, speaker change, speaker identifications, object identifications, meanings derived, active gestures, derived color palettes, or other material characteristics that can be derived through transformation and analysis of the source content or transformational content.

3. The process of claim 1 wherein Linked Cloud Elements reference accessible content to other Cloud Elements and from other Graphical Clouds.

4. The process of claim 1 wherein links are derived through analysis of the source content or transformational content.

5. The process of claim 4 wherein content has been transcribed and at least one of semantic analysis, keyword detection and pattern recognition techniques determine if a particular phrase or segment of the content one comprises a link or points to a link.

6. The process of claim 5 wherein a URL construction is identified by detecting any combination of URL terms including the @ symbol, or “.domain” constructions. Other key words such as “website”, “Internet”, “Instagram account” trigger semantic analysis of adjacent content to determine if a link has been provided or pointed to.

7. The process of claim 5 wherein, key words including “website”, “Internet”, or “Instagram account” trigger semantic analysis of adjacent content to determine if a link has at least one of been or pointed to.

8. The process of claim 5 wherein the system is configured to support metadata from content creators including linking instructions, wherein the system will detect the instruction, suppress the instructive content, and display the link in the appropriate location to the user.

9. The process of claim 1 wherein user input is accepted to determine that a Cloud Element is Linked Cloud Element and user selected Cloud Elements are linked to an external resource.

10. The process of claim 9 wherein user input takes the form of a Cloud Element being selected by a user by the system accepting user commands including clicking on a Cloud Element.

11. The process of claim 9 wherein the external resource is a search engine and linking the element to the search engine results in display of one more entries found by the search engine related to the selected Cloud Element.
